(19) United States
(12) Patent Application Publication
(10) Pub. No.: US 2012/0264461 A1
(43) Pub. Date: Oct. 18, 2012

(54) METHOD FOR GATHERING A RESPONSE OR RESPONSES TO A QUESTION FORMULATED BY A CALL SET-UP ON A TELEPHONE NETWORK

(75) Inventors: Pascal Mayeux, Issy-les-Moulineaux cedex (FR); Jean-Christophe Pupin, Issy-les-Moulineaux cedex (FR); Thomas Rosenblatt, Issy-les-Moulineaux cedex (FR)

(73) Assignee: THOMSON LICENSING

(21) Appl. No.: 13/378,713

(22) PCT Filed: Jun. 2, 2010
(86) PCT No.: PCT/EP10/57741

§ 371 Date: Apr. 2, 2012

(30) Foreign Application Priority Data
Jun. 18, 2009 (FR) 0954108

(51) Int. Cl. H04W 4/14

(52) U.S. Cl. 455/466

(57) ABSTRACT

The invention concerns a telephone network to transmit an instant text message via one or more telephone calls to one or more correspondents, in order to gather almost instantaneously responses to the message.

### SCOPE OF THE INVENTION

The present invention relates to the domain of communication networks. It relates more specifically to a method for gathering a response or Reponses to a question formulated in text form, the question and the response being carried at least partially via a telephone network and even more specifically, to such a method for which the question is transmitted during the call set-up on said telephone network.

### PRIOR ART

If use of the Internet network is today very widespread among users for multiple uses, the telephone communication networks remain a major means to communicate, particularly in the case where instantaneousness is sought in communication. A telephone call guarantees in fact that the correspondent is reached (or is absent) and enables an immediate response to be obtained during an exchange.

Moreover, the user groups (friends, family, work relations, etc.) more and more want to communicate easily by being part of a social network or more simply by exchanging electronic mail (or e-mail).

In this context, there currently lacks a mechanism enabling users to address simple questions to user groups very rapidly to gather almost instantaneously responses to these questions from multiple users.

### SUMMARY OF THE INVENTION

One purpose of the invention is to propose such a mechanism using a telephone communication network to transmit text messages comprising a question to one or a plurality of telephone receivers, these text messages being transmitted via signalization messages of the telephone network for example a telephone call set-up. In order to do this, an application located for example on a server and accessible to users via the Internet network, enables a transmitter of a request to define a text to be transmitted as well as a recipient user or users of a text message (typically defined by their telephone number on the telephone network, or selected from a contact list or directory for example).

The server then generates, almost simultaneously, the different calls to the message recipient users, including in a particular field of a signalization message (for example in the field usually provided to display the name of the calling user), the text message (that comprises a question, in particular for a survey, or agreement for a meeting, etc.). When the recipient users receive the call, the text message is displayed on a screen of the telephone receiver (typically on a small screen of the device) and the action or non-action of the user recipient of the call on his telephone will contribute to generate a response that can be inserted in the signalization message that will be sent to the call transmitter (the server). This received signalization message (for example “call accepted”, “call rejected”, “no response”, pressing of a specific key coded in DTMF—Dual-Tone Multi-Frequency, etc.) is interpreted as a response to the text message sent in the initial call transmitted by the server. Naturally, the receivers that receive the call must know the manner in which the actions that they carry out on their telephone are interpreted to respond to the text message, for example “call accepted” may signify “Yes” in response to a question or “message received” in response to a message giving a meeting place.

To assist users, the initial call transmitted by the server can also comprise a typology of responses for the question. This typology can be transmitted to the telephone receiver and displayed on its screen. This typology identifies correspondences between the responses and actions to be carried out by the operator to indicate this response. For example “Press key 1”→“Yes” and “Press key 2”→“No” and “absence of action”→“No”.

The server can then analyze the different responses received from recipient users of the text message to generate a report summarizing the responses and notify this report to the transmitter of the initial survey. This report can be displayed on a Web page of the server or can be transmitted to all users via electronic mail (e-mail), SMS (Short Message Service) or by pre-recorded audio message or by an audio message generated by vocal synthesis and transmitted by the server in a second telephone call to the recipient users of the first text message.

The advantage of the mechanism proposed is to receive an immediate response from all users due to the use of a telephone network that functions synchronously (the user receiving a call must immediately respond, or refuse the call), contrary to the e-mail or SMS type applications that function asynchronously (the user can respond when he wants after the reception of the message or may not respond at all). Another advantage is that the transmitter of the request is sure that his text message is transmitted to the different users immediately. The transmitter of the survey also knows, due to this application, which users are available or can be reached (if they responded to the telephone call) and which users are not (particularly in the case of an absence of action).

For this purpose the invention relates to a method for gathering a response or responses to a question sent by a first user of a terminal to at least a second user of a telephone receiver, a server being connected to said terminal by a network, said server being connected to the telephone receiver via a telephone network, said question being formulated by means of a text of a message M arriving at the telephone receiver in the form of a telephone call.

According to the invention the following steps are implemented in the server:

(a) reception of an entry or a selection of text of the message M by the user of the terminal,

(b) reception of an entry or a selection of the recipient telephone receiver(s) of the message M,

(c) transmission of one or several telephone calls containing the message M transmitted in a field of a signalization message of each call to the telephone receiver or receivers identified in step (b) for displaying the message M on said telephone receivers,

(d) reception of a signalization message from said telephone receiver(s) in response to the call or calls transmitted in step (c),

(e) interpretation of the signalization message(s) received in step (d) to generate the response(s) to the message M, said responses being presented to the terminal user.

According to an advantageous characteristic of the invention, the signalization message in which is transmitted the message M and that or those received in step (d) in response to the call are defined according to the signalization protocol used by the telephone network.

Advantageously, the signalization message in which is transmitted the message M corresponds to a set-up of a telephone call from the server to the receiver.

According to another characteristic of the invention, the signalization messages received belong to the following set:
acceptance of the call,
rejection of the call,
transfer of the call,
no response.

Advantageously, the signalization message in which the message M is transmitted also comprises a typology of responses to apply to said question by the second user.

According to another particular characteristic of the invention, when at least two telephone receivers are identified in step (b), the responses interpreted in step (e) are synthesized in a report transmitted to the terminal user:
by presentation on a Web page of the server, or
by transmission in an SMS (Short Message Service) message, or
by transmission in an electronic message, or
by transmission in a vocal message.

Advantageously, when at least two telephone receivers are identified in step (b), the calls transmitted in step (c) are transmitted simultaneously.

Advantageously, the network 100 is of IP type.

### BRIEF DESCRIPTION OF THE DRAWINGS

The invention will be better understood upon reading of the detailed description that follows an embodiment of the invention. This description is provided only as an example and refers to the drawings in the appendix in which:

FIG. 1 diagrammatically shows the elements used for the implementation of the invention.

FIG. 2 illustrates the steps of an embodiment of the invention.

FIG. 3 shows an example of the screen that can be presented to the sender of a message transmission request according to the invention.

FIG. 4 shows a screen example that can be presented on a recipient user device of such a message.

### DETAILED DESCRIPTION OF EMBODIMENTS OF THE INVENTION

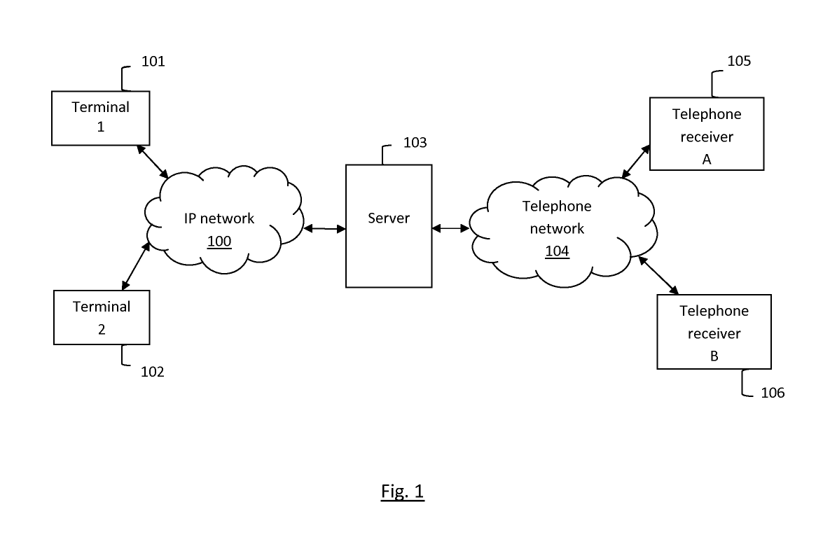

On FIG. 1 is shown an IP (internet Protocol) network 100 such as the Internet network. Two terminals 101 and 102 are shown connected to the network 100. It may concern notably fixed or portable computers, mobile devices able to connect to the network 100, for example devices known under the names or acronyms of PDA (Portable Digital Assistant), smartphones or portable media player devices having means to connect to the network 100. These terminals 101, 102 are equipped with a user interface (keyboard, mouse, stylus, etc.) enabling a user that wants to transmit a message to other users to enter this message or select from among pre-established messages.

A server 103 is also connected to the network IP 100. This server hosts in the embodiment of FIG. 1 an application that enables users connecting to the Web page of this server to transmit messages to telephone receivers.

This application is able to generate telephone calls to telephone receivers 105 and 106 via the telephone network 104. Only two telephone receivers are represented on FIG. 1 but naturally, the application is able to generate calls to a higher number of telephone receivers. The telephone network 104 uses a transmission protocol such as SS7 (Signalling System #7) or ISDN Q.931. It is shown separated from the IP network 100 but it is possible that this telephone network 104 uses a protocol of signalization and transmission of telephone calls physically transiting via an IP network, such as the network 100.

The telephone receivers 105 and 106 are for example telephones according to the standard DECT (Digital Enhanced Cordless Telephone) or mobile telephones, according to one of the standards GSM (Global System for Mobile communications), CDMA (Code Division Multiple Access), UMTS (Universal Mobile Telecommunications System), or EDGE (Enhanced Data Rates for Global Evolution) for example. The telephone receivers 105 and 106 can also be “fixed” or “wired” telephones. To be able to display the text messages received from the message transmission application, the telephone receivers each comprise a display screen, preferably located on the device as shown in the example of FIG. 4.

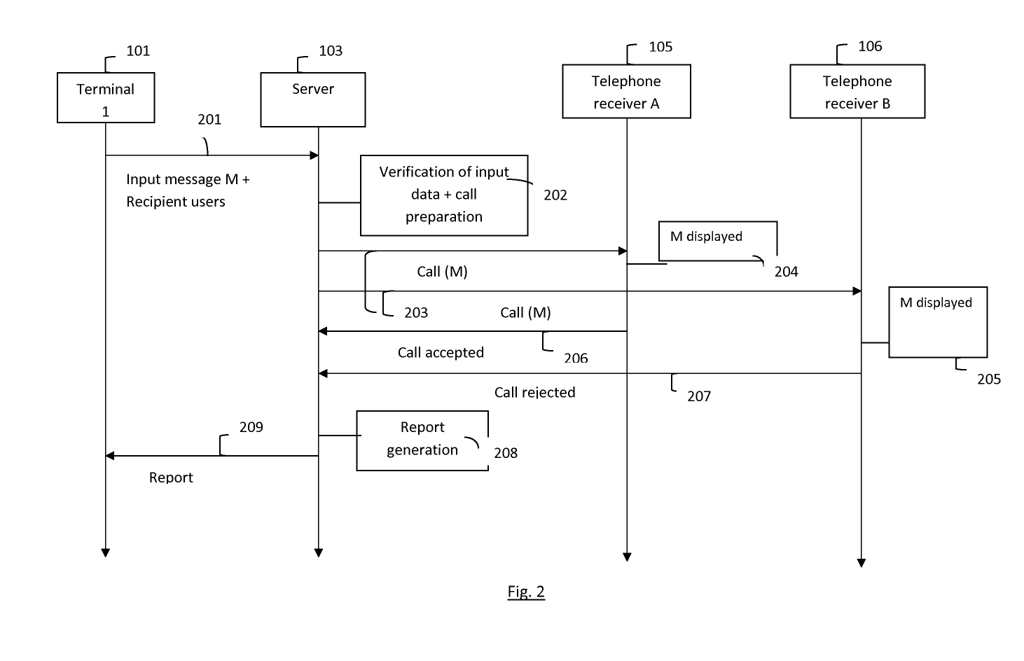

FIG. 2 enables description of the process of transmission of a message from a terminal to telephone receivers and the collection of responses received from these telephone receivers.

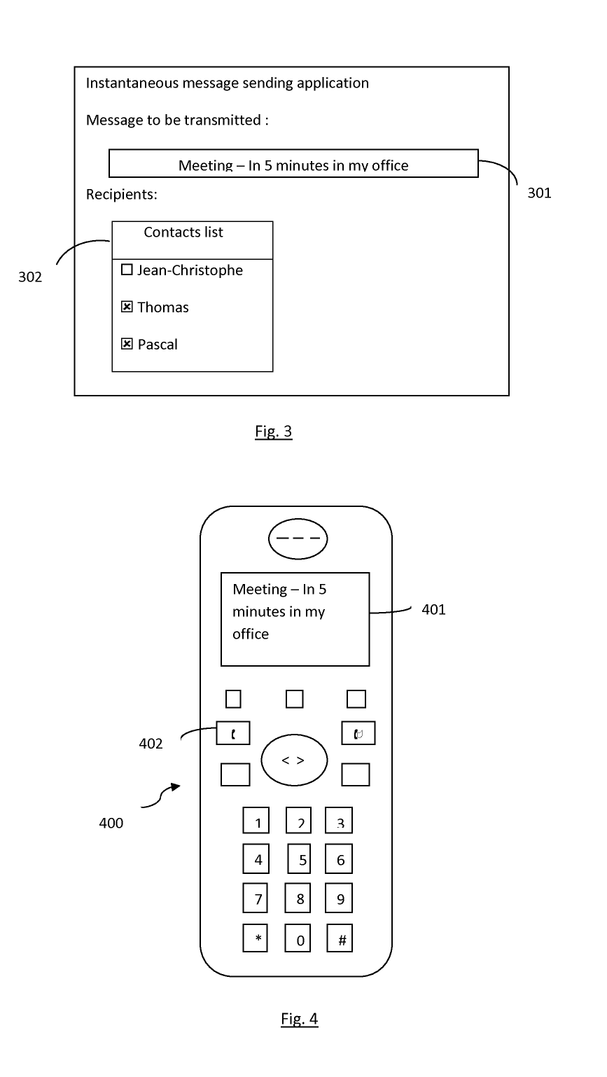

In step 201, the user of terminal 1 connects, on the server 103, to the message transmission application. This presents in the form of a Web page as shown in FIG. 3 that is displayed on the terminal screen 1.

FIG. 3 is only one possible example of the presentation of the application. It can also be envisioned that the user has a choice between several question types, predefined, or that question types are available in which the user can fill-in certain fields. For example, a recorded question type could be:

“MEETING AT______ LOCATION:______>>

The user can then specify the time and place of his meeting.

In the example of FIG. 3, the user enters, in the field 301 of the page, his text message: “MEETING IN 5 MINUTES IN MY OFFICE”

After entering his message, the user selects the recipients of his message. In the example of FIG. 3, it is supposed that the application can recover a list of contacts 302 stored in the terminal 1 and thus this enables the user to simply select the recipients of his message (the telephone numbers of the contacts being stored in the list of contacts).

It can also be envisioned to leave the fields empty so that the user enters directly the telephone numbers of the recipients of his message. In FIG. 3 the case is shown where the user decides to send his message to two of his contacts: Thomas and Pascal (the boxes opposite their names are checked).

Returning to FIG. 2, the application of the server 103 then verifies in step 102 that the data entered conform. In fact, as the text message is transmitted in a signalization message, the format of this message is not free but must comply with the constraints of the transmission protocol used on the telephone network. Once this verification has been made, the application prepares the transmission of calls including the text message (noted as M) selected by the user in a signalization message, for example the field used to transmit the name of the caller user.

The different calls to the selected users (Thomas and Pascal in the example) are sent simultaneously or almost simultaneously in step 203. The text message M sent is immediately displayed on the telephone receiver A (that of Thomas for example) at step 204 and on the telephone receiver B (that of Pascal for example) at step 205. The steps 204 and 205 can be produced quasi-simultaneously.

The message is for example displayed as it appears in FIG. 4 showing a receiver telephone device 400, on the screen 401 of which appears the message entered by the user of terminal 1: “MEETING IN 5 MINUTES IN MY OFFICE”

In step 206, the user of the telephone receiver A (Thomas) accepts the call. To do this he presses for example the key 402 of his device. This generates a signalization message to the server 103 that is interpreted by the application as a positive response to the transmitted text message.

However, the user of telephone receiver B (Pascal) rejects the call in step 207 (by pressing a key or combination of keys specific to his device). A signalization message indicating this call rejection is generated and transmitted to the server 103. This rejection is interpreted by the application as a negative response to the transmitted text message.

The action or absence of action of the user is judged following a predefined period: for example this predefined period corresponds to the duration of the call set-up attempt that is the period corresponding to the ringing of the device. Thus, as soon as an action of the user belonging to a predefined typology is carried out while the message is displayed on the screen of the device and the ringing continues, the response to the question carried in the message M corresponding to this action is re-transmitted to the server 103. Conversely any action produced by the user after the ringing of the device has ceased is not taken into account.

It may be noted that if the message M does not formally contain a question but contains simply information, for example “MEETING IN ROOM 10”, a user action during the predefined period such as the act of accepting the call is interpreted as an acknowledgement of reception of the message. Conversely, a “non response” or an absence of response indicates that the recipient has not read the message.

In step 208, the server 103 generates a report according to the responses (here acceptance or rejection of the call) received from the two recipient telephone receivers of the text message. This report can for example appear as follows:

Thomas: accepts

Pascal: refuses

This report is then made available to the user of terminal 1 in step 209, by displaying of a new Web page containing the report, or by the transmission of an SMS (Short Message Service) message, or in an e-mail, or in a vocal message, etc.

The user having sent the message M to different recipients thus has a response from all recipients almost immediately, as the steps 203 to 209 are displayed for the user almost simultaneously, due to the use of the synchronous telephone network for the transmission of the message M and the recipient responses.

Different applications of this invention can be envisioned. A first application, similar to that which has just been described, is as a tool for meeting reminders: the message M transmitted in the calls can be: “Are you coming to the meeting X?” If the user who receives this message is coming to the meeting, he accepts the call (he picks-up) or presses a predefined key to this effect that is interpreted as a positive response. If he is not coming, he presses another predefined key to this effect or rejects the call and this is interpreted as a negative response. In the case of a non-response from the recipient user of the call containing the message M, this non-response is also interpreted by the application when it generates its report. It will be indicated for example opposite the name of the user as: “no response”.

The invention can also be used for surveys when the questions and responses expected are simple and when it can be ensured that the recipients of the questions know how to respond, that is to say the way in which their actions (rejection, call acceptance, etc.) will be interpreted when they receive the message or that the typology of responses are carried in the message and displayed.

The invention is particularly adapted to communities of users (office colleagues, group of friends, family, etc.) where everyone knows the significance of “codes” of responses to the questions or messages received.

1. A method for gathering at least one response to a question transmitted by a first user of a terminal to at least a second user of at least one telephone receiver, wherein a server is connected to said terminal via a network, said server being connected to the at least one telephone receiver via a telephone network, said question being formed by means of a text in a text message arriving at the at least one telephone receiver in the form of a telephone call, the method comprising the following steps implemented in the server:
a) reception of an entry or a selection of text of the text message by the user of the terminal,
b) reception of an entry or a selection of the at least one telephone receiver for receiving of the text message,
c) transmission of at least one telephone call, containing the text message transmitted in a field of a first signalization message of each of said at least one telephone call, to each of said at least one telephone receiver identified in step b) for a display of the text message on said at least one telephone receiver,
d) reception of at least one second signalization message from said at least one telephone receiver in response to the at least one telephone call transmitted in step c),
e) interpretation of the at least one second signalization message received in step d) to generate a report summarizing said at least one response to the text message, said report being presented to the first user of the terminal.

2. A method according to claim 1, wherein the first and the at least one second signalization messages are defined according to a signalization protocol used by the telephone network.

3. A method according to claim 2, wherein the first signalization message corresponds to a telephone call set-up from the server to the at least one telephone receiver.

4. A method according to claim 1, wherein the first signalization message also comprises a typology of responses to apply to said question by the second user.

5. A method according to claim 1, wherein the at least one second signalization messages belongs to the following set:
acceptance of the at least one telephone call,
rejection of the at least one telephone call,
transfer of the at least one telephone call,
no response to the at least one telephone call.

6. A method according to claim 1, wherein when at least two telephone receivers are identified in step b), the responses interpreted in step e) are synthesized in said report transmitted:
by presentation on a Web page of the server, or
by transmission in an Short Message Service message, or
by transmission in an electronic mail message, or
by transmission in a vocal message.

7. A method according to claim 1, wherein when at least two telephone receivers are identified in step b), the at least two telephone calls transmitted in step c) are transmitted simultaneously.

8. A method according to claim 1, wherein the network is of an Internet Protocol type.
